(19) United States
(12) Patent Application Publication
(10) Pub. No.: US 2005/0199667 A1
(43) Pub. Date: Sep. 15, 2005

(54) Shopping cart cup holder

(76) Inventors: Giuseppe Cappellino, Tecumseh (CA); Carlo Severini, Tecumseh (CA)

Correspondence Address: BAKER & DANIELS LLP;111 E. WAYNE STREET, SUITE 800, FORT WAYNE, IN, 46802, US

(21) Appl. No.: 10/952,612

(22) Filed: Sep. 29, 2004

(30) Foreign Application Priority Data
Feb. 27, 2004 (CA) 2,459,150

(51) Int. Cl. B60R 7/00

(52) U.S. Cl. 224/411; 280/33.992

(57) ABSTRACT

A cup holder mountable on a shopping cart comprises a cup-holding member and a clamp member. The clamp member comprises at least one clamp having upper and lower arms being adapted to fit over and embrace both the cart handle and a bar defining the edge of the cart basket that is parallel to the handle. The upper arm is connected to the cup-holding member, which extends horizontally from the cart handle and includes an aperture for receiving a beverage container.

The invention relates to the field of beverage container holders for use with shopping carts.

### BACKGROUND OF THE INVENTION

Shoppers may wish to carry a beverage with them while shopping. However, it is desirable to have both hands free in order to, for example, examine goods or pay for purchases. Where the shopper is pushing a shopping cart, both hands may be required to navigate the cart.

The prior art discloses various cup holders that are attachable to shopping carts.

Canadian Patent No. 2,205,141 discloses a tray-like receptacle for holding a beverage container for use with a shopping cart. The receptacle is attached to the cart handle and extends away therefrom. The receptacle may lack stability, as it is secured to the cart only along one edge. The weight of the beverage, for example, could cause the tray to swing downwards. In addition, the holder is not conveniently removable from the cart.

U.S. Pat. No. 5,494,306 discloses a cup holder for use with a shopping cart. The holder is mounted onto the handle of the cart and includes a U-shaped wire frame that is secured to the handle by wrapping the wire ends around the handle. This holder is not suitable for use with a round handle, as it would be prone to swinging downward. In addition, it is not conveniently removable from the cart, as the handle of the cart must be removed first.

U.S. Pat. No. 6,644,524 discloses a cup holder for use with a shopping cart. The holder is mounted to the movable portion of the cart that defines a child seat. The holder lacks stability as the movable portion of the cart could be accidentally pushed while the holder is in use.

What is needed, therefore, is a cup holder for use with a shopping cart that is stably attached to the cart without risk of tipping, and that is easily and conveniently removable from the cart.

### SUMMARY OF THE INVENTION

An object of the present invention is to provide a cup holder that is securely attachable to a shopping cart.

A further object of the present invention is to provide a cup holder that is conveniently and easily attachable and removable from a shopping cart.

The cup holder comprises a clamp member and a cup-holding member. The clamp member comprises at least one clamp having upper and lower arms that are connected at one end. The clamp member is attached to the cart by positioning the clamp arms so that they wrap around or embrace the cart's handle and a bar that defines the edge of the cart's basket and is parallel to the handle. The upper arm is attached to the cup-holding member, which extends horizontally from the cart's handle. The cup-holding member also includes an aperture suitable for receiving a beverage container.

The cup holder is thus anchored onto the cart both at the handle and at the bar, meaning that the cup-holding member is not prone to tipping or swinging downward. The arms may be made from a resilient material that allows the arms to be spread apart during installation and also allows them to snap back into position around the handle and bar. This feature greatly facilitates the installation and removal of the cup holder on the shopping cart. Optionally, the unconnected end of the lower arm may be bolted to the upper arm.

The cup holder may also include a support bracket pivotally connected to the cup holder and extending vertically downward from the cup holder beneath the aperture. The bracket pivots out of the vertical position to allow for the nesting of shopping carts.

### BRIEF DESCRIPTION OF THE DRAWINGS

FIG. 1 is a perspective view of the cup holder as it fits onto the shopping cart.

FIG. 2 is a side view of the cup holder illustrating the pivotal movement of the rear wall of a shopping cart in relation to the cup holder, and the pivoting motion of the optional support bracket of the cup holder.

### DETAILED DESCRIPTION OF THE DRAWINGS

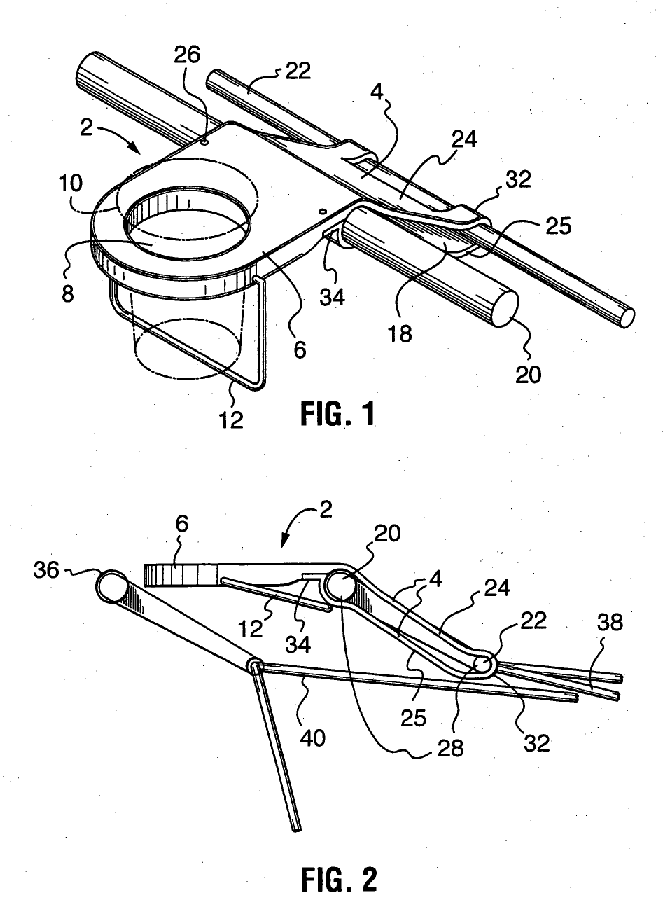

In FIG. 1, the one-piece cup holder 2 comprises a clamp member 4 and a cup-holding member 6. The cup-holding member has an aperture 8 for receiving a beverage container 10. The aperture 8 is preferably of a size to accommodate a standard coffee cup. The cup-holding member 6 extends horizontally from the shopping cart handle 20. A support bracket 12 may also be included. The bracket 12 extends vertically downward from the cup-holding member 6 beneath the aperture 8 and is pivotally connected to the cup-holding member 6, preferably by clipping onto the cup-holding member 6.

The clamp member 4 attaches the cup holder to the shopping cart. The clamp member 4 comprises at least one, but preferably two clamps 18. Each clamp has upper and lower arms 24, 25 joined at one end 32. The upper arm is connected to the cup-holding member 6, while the lower arm has a free end 34. The arms 24,25 are adapted to fit over and embrace the shopping cart handle 20 and the bar defining the edge of the basket 22. The clamp member 4 may be made from flexible plastic that allows the arms 24,25 of the clamps 18 to stretch apart and then snap and lock into position. Optionally, the clamps 18 may be secured to the cart with screws or bolts 26 that connect the free end 34 of the lower arm 25 to the upper arm 24.

The cup holder does not prevent the nesting of shopping carts. As illustrated in FIG. 2, the cup-holder 2 remains stationary when a second shopping cart 36 is nested with the first cart 28. Bracket 12 pivots out of its vertical position, making room for the basket 40 of the second cart 36. The back wall 38 of the first cart 28 swings upward but does not affect the position of the cup-holder 2.

1. A cup holder removably attachable to a shopping cart with a handle and a bar defining the top edge of the cart's basket, said bar being parallel to the handle; said cup holder comprising:
a cup-holding member with an aperture for receiving a beverage container;
at least one clamp member having an upper arm and a lower arm joined at a first end, a second end of the upper arm being connected to the cup-holding member, the upper and lower arms being adapted to embrace the bar and handle of the cart;
wherein said cup-holding member extends horizontally from the handle of the cart.

2. A cup holder as claimed in claim 1 wherein said lower arm are bolted to said upper arm at said second end of the upper arm.

3. A cup holder as claimed in claim 1 wherein said upper and lower arms are composed of resilient material so that the arms may be spread apart for installation on the cart and the arms will snap back once in position, to securely engage the bar and handle.

4. A cup holder as claimed in claim 1 further comprising a support bracket extending vertically from said cup-holding member beneath said aperture.

5. A cup holder as claimed in claim 4 wherein said support bracket is pivotally connected to said cup-holding member to allow said bracket to pivot out of a vertical position in order to accommodate a second shopping cart nesting with the shopping cart.
